(19) United States
(12) Patent Application Publication
(10) Pub. No.: US 2014/0260876 A1
(43) Pub. Date: Sep. 18, 2014

(54) TOOTH FOR CIRCULAR SAW OR MOWER DRUM

(71) Applicant: PRENBEC EQUIPMENT INC., MONTREAL (QUEBEC) (CA)

(72) Inventors: Charles MACLENNAN, Rigaud (CA); Robert MACLENNAN, Pointe-Claire (CA); Denis RIOUX, Rimouski (CA); Stephane LAROUCHE, Rimouski (CA)

(73) Assignee: PRENBEC EQUIPMENT INC., MONTREAL (QUEBEC) (CA)

(21) Appl. No.: 13/868,751

(22) Filed: Apr. 23, 2013

Related U.S. Application Data
(60) Provisional application No. 61/787,318, filed on Mar. 15, 2013.

(51) Int. Cl. B27B 33/12

(52) U.S. Cl. CPC B27B 33/12
USPC 83/835

(57) ABSTRACT

A saw tooth for mounting onto a holder of a circular saw or of a mower drum is provided. The tooth has a mounting end for mounting against a component of the holder, a cutting end, opposite to the mounting end, the cutting end being provided with at least one cutting edge; and a plurality of sides extending from the mounting end to the cutting end. The plurality of sides include at least one holder side operatively mountable against the holder and at least one outer side opposite to the holder side the outer side being non-linear, diverging from the mounting end to the cutting end and having a contour slope which increases from the mounting end to the cutting end. The tooth thereby provides a greater clearance at its mounting end, and a greater kerf at its cutting end.

### FIELD OF THE INVENTION

The present invention relates to the field of tree felling and, more particularly, relates to a tooth for a circular saw or a mower drum.

### BACKGROUND

Tree felling machines typically include a circular saw disk which rotates at high speed. The saw disk has several teeth mounted on holders all around its periphery. The saw disk is moved horizontally through the tree, and as it advances, it creates a kerf or cut in the trunk of the tree.

A tooth for a circular saw generally has a mounting end and a cutting end and four sides diverging out from the mounting to the cutting end. The four sides are identical with a straight, linear profile. The cutting end is provided with four pointed tips at its corners, and four cutting edges extend between the cutting tips.

In the field of tree felling, the kerf refers to the width of the cut made by a saw in the trunk of the tree. The kerf of a typical four-sided tooth is thus the width of either one of the cutting edges, which also corresponds to the distance between two adjacent cutting tips.

In some applications, there is a need to increase the kerf of the teeth. In order for a circular saw to operate smoothly and steadily in high energy applications, the disk has to be substantial enough to absorb vibrations and avoid wobbling. The circular disk must be able to advance within the tree without interference, and thus the saw teeth must make a cut large enough for the disk to pass through the kerf.

Increasing the kerf also allows for providing more clearance for the outer, exposed side of the tooth and holder, as it bites into the tree. In other words, the distance between the cutting end and the mounting end of a tooth must be great enough to ensure that the cutting edge remains the sole portion of the tooth in contact with the tree, even as the tooth wears, otherwise the efficiency of the cutting operation is reduced. The holder and bolt retaining the tooth should not wear upon the tree.

One proposed solution for increasing the kerf of a circular saw tooth consists in increasing its height. However, increasing the height of the tooth also increases the stress and load applied on the rotating disk, resulting in energy losses. Indeed, a longer tooth tends to increase the wear and tear of the disk, since the impact on the cutting edge of the tooth occurs further away from the periphery of the disk (i.e. the radial distance between the point of impact of the tooth and the center of the disk is greater), thereby increasing stress on the rotating disk.

Another solution consists in machining the rotating disk so that the outer side of tooth extends slightly more outwardly, with an “open angle”, which can also increase the side clearance of the tooth and holder, but can tend to tear the tooth off the rotating disk. Such an outwardly affixed tooth also tends to increase the stress on the tooth because the tooth tends to be “ripped-off” due to an increased moment resulting from the outwardly-disposed tooth.

Another aspect to consider is that, in most cases, the teeth are mounted on existing holders which have a specific size and configuration. In order to avoid having to replace existing holders or saw, the teeth must have certain specific characteristics so that they can still be mounted on existing holders.

In some application, it would also be desirable to reduce as much as possible the possibility of the tooth to move or wobble within its holder. It would also be desirable to increase the pocket formed by the front end of the tooth.

In view of the above, there is thus a need for an improved saw tooth that would be able to overcome or at least minimize some of the above-discussed concerns. It would be desirable for the improved saw tooth to have a wider kerf than existing four-sided saw teeth, without increasing its height. It would also be desirable for the improved tooth to be mountable to existing tooth holders. It would also be desirable for the tooth to limit or reduce wobbling within its holder. It would also be desirable to provide a tooth with similar manufacturing costs as those for existing saw teeth.

### SUMMARY OF THE INVENTION

The present invention concerns a saw tooth for mounting onto a holder of a circular saw or of a mower drum. The tooth comprises a mounting end for mounting against a component of the holder, a cutting end opposite to the mounting end, the cutting end being provided with at least one cutting edge; and a plurality of sides extending from the mounting end to the cutting end. The plurality of sides includes at least one holder side operatively mountable against the holder, and at least one outer side opposite to the holder side. The outer side is non-linear, diverging from the mounting end to the cutting end and having a contour slope which increases from the mounting end to the cutting end. The holder can be either fixed/integral to the disk, or replaceable.

In an embodiment, the outer side of the tooth comprises at least two different diverging segments, the outer side of the tooth being non-linear and diverging out from the mounting end to the cutting end, so as to enable the at least one cutting edge to extend beyond a corresponding mounting edge by at least 0.2 inches, thereby increasing a transversal clearance of the tooth.

In an embodiment, the outer side of the tooth is positioned, shaped and sized so to increase in slope from the mounting end to the cutting end, thereby providing a greater clearance for the tooth at its mounting end, and providing a greater kerf for the tooth at its cutting end.

In an embodiment, the invention concerns a tooth for use with a rotatable circular saw. The tooth is mountable onto a holder of the circular saw, and includes a mounting end for mounting against a component of the holder; a cutting end, opposite to the mounting end, the cutting end being provided with a plurality of cutting edges for cutting applications; and a plurality of sides diverging from the mounting end to the cutting edges of the cutting end. The plurality of sides include at least one holder side mountable against the holder of the circular saw, and at least one outer side opposite to the holder side, the outer side of the tooth being concavely non-linear.

The present invention also concerns an assembly for tree felling applications, the assembly comprising at least one tooth as described above; and at least one holder of a circular saw or mower drum.

The present invention also concerns a circular saw for tree felling applications. The saw includes a rotatable saw disk having an outer periphery, a plurality of tooth holders protruding from said outer periphery; and a plurality of teeth as described above, each of the teeth being mounted onto a respective one of the tooth holders.

Advantageously, the tooth of the present invention provides an increased clearance for the tooth holder while maintaining a short height distance, thus increasing the life of the disk while remaining cost effective.

### BRIEF DESCRIPTION OF THE DRAWINGS

Other objects, advantages, and features will become more apparent upon reading the following non-restrictive description of the embodiments thereof, given for the purpose of exemplification only, with reference to the accompanying drawings in which:

FIG. 1 is a top perspective view of a tooth, according to an embodiment of the invention.

FIG. 2 is a bottom perspective view of the tooth of FIG. 1.

FIG. 3 is a top view of the tooth of FIG. 1.

FIG. 4 is a bottom view of the tooth of FIG. 1.

FIG. 5 is a side view of the tooth of FIG. 1.

FIG. 6 is a cross-sectional view of the tooth of FIG. 1, taken along line 6-6.

FIG. 7 is a side view of the tooth of FIG. 1, mounted onto a circular saw disk holder.

FIG. 8 is an exploded view of the elements of FIG. 7.

FIG. 9 is a perspective view of a circular saw with holders and teeth mounted thereon.

FIG. 10 is a perspective view of a mower drum with holders and teeth mounted thereon.

FIG. 11 is a top perspective view of a tooth, according to another embodiment of the invention.

FIG. 12 is a bottom perspective view of the tooth of FIG. 11.

FIG. 13 is a top view of the tooth of FIG. 11.

FIG. 14 is a bottom view of the tooth of FIG. 11.

FIG. 15 is a side view of the tooth of FIG. 11.

FIG. 16 is a cross-sectional view of the tooth of FIG. 11, taken along line 16-16.

FIG. 17 is a side view of the tooth of FIG. 11, mounted onto a circular saw disk holder.

FIG. 18 is an exploded view of the elements of FIG. 17.

FIG. 19 is a perspective view of a circular saw with teeth mounted thereon.

FIG. 20 is an enlarged partial side view of one tooth mounted on a holder of the circular saw of FIG. 19, according to an embodiment of the invention. A prior art straight-side tooth is shown in stippled line.

### DETAILED DESCRIPTION

In the following description, the same numerical references refer to similar elements. The embodiments described in the present description are preferred embodiments only; they are given solely for exemplification purposes.

In addition, it will be appreciated that positional descriptions such as “top”, “bottom”, “side”, “lower”, “upper”, and the like should, unless otherwise indicated, be taken in the context of the figures and should not be considered as limiting or as implying a required orientation during use.

An advantage from the above-discussed tooth according to the present invention is that it substantially increases the kerf and side clearance of the tooth, without having to increase the tooth's height. The proposed tooth also allows keeping the manufacturing costs relatively low, or at least comparable to the manufacturing costs of an existing tooth, since the tooth configuration is simple and does not require an extensive number of machining steps. Another advantage of the tooth is that it is sized and configured so as to be mountable onto existing saw and/or mower drum holders.

### NUMERAL REFERENCES USED IN THE FIGURES

8 prior art straight side tooth
10, 110 tooth
11, 111 mounting edge
12, 112 mounting end
13, 113 bottom face of mounting end
14, 114 cutting end
16, 116 cutting edge
18, 118 sides
18a, 118a holder side
18c, 118c outer side
19, 119 lower end of holder side
20, 120 segments
20i, 120i first segment
20i, 120i second segment
22, 122 concave profile
24, 124 span of cutting end
26, 126 span of mounting end
28, 128 beveled bottom corners
30, 130 beveled side corners
32, 132 corner cutting edge
34, 134 cutting tip
36, 136 inner flat surface
38, 138 curved C-shaped surface
40, 140 recessed profile of cutting end
42, 142 central bore
44, 144 central axis
L longitudinal direction
T transverse direction
R radius of curvature
h height of tooth
tc transverse clearance
k kerf
200, 1200, 2200 holder
202, 1202, 2202 component of holder
204, 1204, 2204 shoulder portion
300, 1300, 2300 circular saw
400 mower drum

Referring to FIGS. 1 to 6, a tooth 10 according to a first embodiment is shown. The tooth 10 can be used on machinery for cutting and felling trees, such as a circular saw 300, as shown in FIG. 9. Alternatively, the tooth can be used on equipment for clearing brushwood, such as a mower drum 400, as show in FIG. 10.

Referring to FIGS. 1 to 10, the saw tooth 10 is mountable onto the holder 200 of a circular saw 300 or of a mower drum 400, the holder 200 being either integrally part of the saw or drum, or detachable.

The tooth 10 has a mounting end 12, a cutting end 14 and several sides 18. The mounted end 12 is for mounting against a component 202 of the holder 200. The cutting end 14 is opposite to the mounting end 12, and is provided with at least one cutting edge 16.

The sides 18 extend from the mounting end 12 to the cutting end 14. The tooth 10 includes at least one holder side 18a, which is operatively mountable against the holder 200 and at least one outer side 18c, which is opposite to the holder side 18a. The outer or exposed side 18c is non-linear and diverges from the mounting end 12 to the cutting end 14. The outer side 19c has a contour slope which increases from the mounting end 12 to the cutting end 14.

As best shown in FIGS. 3 to 5, the outer side 18c of the tooth 10 has a concave profile 22. The outer side 18c of the tooth 10 is thus formed by a series, and in the present case, an infinite number of different diverging segments. The profile 22 is concave at least along a longitudinal direction L. In other words, the plurality of sides 18 include at least one holder side 18a mountable against a holder of a circular saw, and at least one outer side 18c opposite to the holder side 18a, the outer side 18c of the tooth 10 being concavely non-linear. The profile can also be concave along a transverse direction; however it is the concavity of the side 18c along the longitudinal direction, i.e. from the mounting to cutting end 12, 14, which can increase the side clearance and kerf. In this first embodiment of the tooth 10, the concave profile 22 has a radius of curvature of between 9 and 12 inches, and preferably about 11 inches or 28 cm. By “about 11 inches”, it is understood that the radius can be 11 inches±10%. Of course, for other embodiments of the tooth, other configurations and radius of curvature can be used.

Referring to FIGS. 3 and 5, the span 24 of the cutting end 14 is greater than a span 26 of the mounting end 12. As can be appreciated, the span 24 of the cutting end 14 corresponds to the length of cutting edge 16, and is also referred to as the kerf of the tooth. As explained above, the kerf 24 (i.e. span of the cutting edge 14) is the width of the cut made by a saw or other cutting device. The kerf 24 of the tooth 10 is preferably greater than 2.1 inches and even more preferably more than 2.4 inches. In the present embodiment, the kerf 24 is about 2.49 inches. Of course, for other embodiments, other kerf dimensions can be considered.

Referring to FIG. 5, the tooth can have a height h which is between about 1.5 and 2 inches, but preferably, the height is below about 1.8 inches. Providing the tooth 10 with such a reduced height can help reduce the load applied on the circular saw disk when in operation. The width or span 26 of the mounting end 12 can be between about 1.6 and 2.1 inches, and is preferably about 2 inches. As best shown in FIG. 8, the span of the mounting end 12 is sized to fit on the holder 200, and thus preferably corresponds to the width of the holder 200.

Referring to FIGS. 3 and 4, the side or transverse clearance of the tooth tc is the largest distance between the cutting edge 16c and the mounting edge 11c. The transverse clearance tc also corresponds to the transverse distance between one of the cutting tips 34b, 34c and the corresponding edge 11c of the mounting end 12. This distance must be wide enough so that when the tooth passes through the cutting material, such as the trunk of a tree, the cutting edge 16c and cutting tips 34b, 34c are the first, and preferably the sole, elements in contact with the trunk. As is well known in the art, the face of the cutting side 18c and its corresponding holder must avoid as much as possible contacting and/or rubbing against the trunk, in order to avoid friction and overheating. In the present embodiment, the transverse clearance tc of the tooth is greater than 0.15 inch, such as about 0.2 inch, and is preferably about 0.24 inch.

As can be appreciated, the tooth 10 constructed according to this first embodiment as a height of 1.79 inch, a kerf of 2.49 inches and a side or transverse clearance of 0.24 inch.

Of course, the dimensions provided are given for the embodiment of the tooth illustrated in the Figures. In other embodiments of the tooth, the dimensions for the base, kerf, length, radius of curvature can vary. For example, in another embodiment, the base of the tooth is about 1.625 inches square and the kerf is about 2.1 inches. Yet in another embodiment, the base is about 2.1 inches and the kerf of about 2.4 inches.

Referring now of FIGS. 7 and 8, the holder side 18a has a lower portion 19a sized and configured to be seated against a shoulder portion 204 of the holder 200. The lower portion 19a of the holder side 18a preferably forms an angle between about 4 and 6 degrees with a central axis 44 of the tooth 10, so as to be compatible with existing holders.

In the present embodiment, the tooth 10 is symmetrical. The tooth 10 is thus mountable in four different orientations onto the holder 200, by rotating the tooth by about 90 degrees relative to the central axis 44 of the tooth.

In other embodiments, it can be considered to have only the holder side 18a and the outer side 18c as substantially identical. In this case, the tooth 10 would include only two cutting edges, 16a and 16c. Preferably, however the tooth 10 has four cutting edges, 16a-16d, allowing it to be rotated in four different positions. The cutting edge 16c preferably has a V-shape.

It can also be considered to have all cutting edges 16 of the same type. By “same type”, it is meant that the outlines of the edges are identical, as in the embodiments of the tooth 10,110 shown in the Figures. Alternatively, it is possible for the cutting edges to be of different types, for example as described in U.S. Pat. No. 8,061,396. In this case, a first pair of opposed cutting edges can have a linear shape or profile, while the second pair of opposed cutting edges have a curved profile.

Referring to FIGS. 2, 4 and 5, the tooth 10 has at least one beveled bottom corner 28a at the intersection of one of the holder side (18a) and the bottom face 13 of the mounting end 12. In the embodiment of FIGS. 1 to 6, all four corners 28a-28d of the tooth are bevelled. While bevelled edges are preferred, in other embodiments, the edges of the tooth are not necessarily beveled.

The tooth 10 also has at least one beveled side corner 30c at the intersection of two adjacent sides 18b, 18c. Preferably, the tooth 10 includes four beveled corners 30a-30d. Each beveled side corner 30 includes a corner cutting edge 32. As best show in FIG. 3, in which the tooth 10 is viewed from its front/top side, the cutting edge can include the cutting edge 16c but also the corner cutting edges 32b and 32c. The beveled corners 30a-30d preferably have a flat and smooth surface. The cutting edges 32a-32d are preferably 0.315 inch in width. Providing the tooth with beveled corners can reduce the likelihood of chipping or fracturing of the tooth. It also can facilitate manipulation of the tooth during replacement/repositioning operations.

Referring to FIGS. 1, 3 and 6, the cutting end 14 of the tooth 10 is provided with at least one protruding cutting tip 34c, and preferably has four cutting tips 34a-34d. The cutting end 14 comprises four protruding cutting tips 34a, 34b, 34c, 34d. The cutting tips 34a-d have an inner flat surface 36, which forms an angle of about 40 degrees with a plane extending between the top of the cutting tips. It can also be said that the inner flat surfaces 36a-36d each form an angle of 50 degrees with the bottom face 13 of the mounting end 12. The cutting end 14 has a recessed profile 40.

As best shown in FIG. 3, the inner flat surfaces 36a-36d are substantially triangular. In addition, the protruding cutting tips 34a-d have a curved C-shaped surface 38c, resulting from the machining of the tooth 10.

Referring to FIGS. 1 to 6, the tooth 10 also has a central bore which extends from the mounting end 12 to the cutting end 14, and which is preferably threaded to accommodate a mounting screw, such as shown in FIG. 8. Of course, in other embodiments, a mounting shaft can extend from beneath the mounting, so as to cooperate with the holder 200 and a bolt.

Referring now to FIGS. 11 to 16, another embodiment of a tooth is shown. In this case, the outer side 118c of the tooth 110 has two different diverging segments 120i and 120ii. The segment 120ii of the outer side 118c has a contour slope which is greater than the contour slope of the preceding segment 120i. While the present embodiment only includes two segments 120i, 120ii, it can of course be considered for the outer side 118c to include three or more segments. In this case, each of the segments, going from the mounting end 112 to the cutting end 114 has a contour slope which is greater than a contour slope of a preceding segment. The outer side of the tooth can thus include a series of different diverging segments. Consequently, the span of the cutting end 114 is greater than the span of the mounting end 112.

Referring to FIGS. 12 and 15-18, the first segment 120i of the cutting side 118c forms an angle of about 5° with the central axis 144 passing through the tooth 110, while the second segment 120ii forms an angle of about 6.5° with axis 114. In this embodiment of the tooth 110, the cutting side 118c and the holder side 118a are identical, and so the lower portion 119a (identified in FIG. 17) of the holder side 118a corresponds to the lower segment 120i of side 118a. Since the segment 120i is angled at about 5°, the tooth 110 can be mounted to existing holders commonly used in the tree felling industry, and be perfectly seated on component 1204 of the holder 1200, identified in FIG. 18.

Referring to FIG. 15, height h of the tooth 110 is preferably between 1.7 and 2 inches, and more preferably of 1.9 inches. The width 126 of the mounting end is preferably between 1.9 and 2.1 inches, and more preferably of 2 inches. The span 124, which in the present case also corresponds to the kerf k of the tooth (identified in FIG. 13) is preferably between 2.3 and 2.5 inches, and more preferably of 2.4 inches. The transverse clearance tc is preferably less than 1.8 inch, and preferably of 1.9 inch.

Referring to FIGS. 11 to 18, the remaining aspects of the tooth 110 are similar to those of the tooth 10 shown in FIGS. 1 to 10. The four sides 118a-d are preferably all identical. The tooth 110 preferably has beveled bottom corners 128 at the intersection of the sides 118 and the bottom face 113. The tooth 110 is provided with four edges 116 having a V-shape, with a recessed top surface profile. The tooth 110 has four pointed tips 134a-d, and four beveled corners 130a-130d. The corners 130a-130d terminate at their respective corner cutting edges 132a-132d. The beveled surface of the corners is preferably smooth and flat, and the corner cutting edges preferably measure about 0.156 inches. While preferred, beveled edges are not required.

As shown in FIG. 16-18, the tooth 110 has a central bore 142, preferably being threaded for affixing the tooth 110 onto a holder 1200, which can either be mounted or integral to a circular saw, or on a mower drum.

Referring now to FIGS. 19 and 20, a different variant of a circular saw 2300 is shown. In this case, the holders 2200 are integral to the saw, and they protrude from the outer periphery of the saw 2300. Teeth according to the first embodiment are affixed on the outer periphery of the saw. As shown in FIG. 20, the mounting end 12 of the tooth 10 is mounted against component 2202 of the holder. The holder side 18a of the tooth has a curved profile which substantially matches a surface 2204 of the holder. More specifically, the lower portion 19a of the holder side 18a substantially matches the outline of surface 2204. The holder 2200 being integral to the saw 2300, it can also be said that the holder side 18a, and more specifically its lower portion 19a, has a curved profile which closely fits the outer surface 2204 of the circular saw 2300.

FIG. 20 also better shows how the cutting tips and cutting edge of the tooth extend beyond the mounting end, providing an increased clearance tc compared to a tooth of similar height, but with a linear outer side. Of course, it can be considered to mount the second embodiment of the tooth 110 to this variant of the saw 2300. In this case, the lower segment 120i of the tooth 110 would closely fit the shoulder portion 2204 of the holder. In FIG. 20, a prior art, straight side tooth 8 is shown in stippled lines. As can be appreciated, when comparing the tooth 10 versus the prior art tooth 8, the clearance provided between the tip of the tooth 10 and the mounting end and holder side is greater than for the tooth 8. The tooth 10 is also slightly smaller in height compared to the tooth 8. Such slight differences provide non-trivial advantages, especially for high speed/high energy applications.

An advantage of such characteristics of the curved holder side of the tooth is that the mounting of the tooth onto the holder is more resistant to stress and high impacts, and thus the likelihood of the tooth ripping off is reduced. It also increases the size of the “pocket” frontward of the tooth.

Yet another advantage of the non-linear side tooth described above is that it fits existing holders on which standard/straight side teeth can be mounted. Standard dimensions of existing straight side teeth include a 2 inch square base (which can slightly vary depending on manufacturing tolerances/bevelling of edges); a 5° angle on the side of the tooth (and holder seat); a threaded hole for accommodating a 1 inch bolt and a kerf from 2.25 to 2.3125 inches. The improved non-linear side tooth described in the present application not only provides a larger kerf over a standard straight-side tooth, it does so without increasing the stress acting against the disk and/or the corresponding holder, and it remains cost effective, providing more clearance, more tip life (the tips being longer) in a shorter (in terms of height) tooth. Providing the tooth with an increased clearance, while minimizing its height reduces the stress incurred by the rotating disk, which in turn increases the operational life of the disk.

To summarize, and referring to FIGS. 1-20, each embodiment 10, 110 of the tooth has an outer side 18c, 118c with least two different diverging segments, the outer side 18c, 118c of the tooth being non-linear and diverging out from the mounting end 12,112 to the cutting end 14,114, so as to enable the at least one cutting edge 16c, 116c to extend beyond a corresponding mounting edge 11c, 111c by at least about 0.15 inch, and preferably about 0.2 inch, thereby increasing a transversal clearance tc of the tooth 10, 110.

In other words, the outer side 18c, 118c of the tooth 10, 110 is positioned, shaped and sized so as to increase in slope from the mounting end 12, 112 to the cutting end 14,114, thereby providing a greater clearance tc for the tooth at its mounting end 12, 112, and providing a greater kerf k for the tooth at its cutting end 14,114. Preferably the mounting side is also curved, so as to closely fit an outer surface of a holder and/or circular saw.

The invention also concerns an assembly for tree felling applications, the assembly comprising at least one tooth according to both embodiments 10, 110 described above, and at least one holder 200, 1200, 2200.

The invention also concerns a circular saw comprising a rotatable saw disk having an outer periphery; several tooth holders being either mountable or integral to the outer periphery, and a several teeth as defined above.

As may now be better appreciated, the present invention is an improvement over other related tooth for circular saw or mower drum known in the prior art in that, by virtue of its design, size and configuration, and especially due to its non-linear outer side with diverging segments, the tooth according to the present invention provides a greater kerf and transverse clearance over similar prior art tooth for tree feeling/clearing/brushing applications, while keeping the manufacturing costs reasonable. Providing the holder side of the tooth with a non-linear, and preferably curved or concave profile also allows for a mounting which is more stable and resistant to impacts.

The scope of the claims should not be limited by the preferred embodiments set forth in the examples, but should be given the broadest interpretation consistent with the description as a whole.

1. A saw tooth for mounting onto a holder of a circular saw or of a mower drum, the tooth comprising:
a mounting end for mounting against a component of the holder;
a cutting end, opposite to the mounting end, the cutting end being provided with at least one cutting edge; and
a plurality of sides extending from the mounting end to the cutting end, including at least one holder side operatively mountable against the holder, and at least one outer side opposite to the holder side, the outer side being non-linear, diverging from the mounting end to the cutting end and having a contour slope which increases from the mounting end to the cutting end.

2. A tooth according to claim 1, wherein the outer side of the tooth comprises at least two different diverging segments.

3. A tooth according to claim 2, wherein each segment of the outer side of the tooth, going from the mounting end to the cutting end, has a contour slope which is greater than a contour slope of a preceding segment.

4. A tooth according to claim 1, wherein the outer side of the tooth comprises a concave profile.

5. A tooth according to claim 4, wherein the profile is concave along a longitudinal direction.

6. A tooth according to claim 5, wherein the concave profile has a radius of curvature of between 9 and 12 inches.

7. A tooth according to claim 6, wherein a height of the tooth is between 1.7 and 1.9 inches.

8. A tooth according to claim 7, wherein a width of the mounting end is between 1.6 and 2.1 inches.

9. The saw tooth according to claim 1, wherein a kerf of the tooth is greater than 2.1 inches.

10. A tooth according to claim 1, wherein the holder side has a lower portion sized and configured to be seated against a shoulder portion of the holder.

11. A tooth according to claim 1, said tooth being mountable in four different orientations onto said holder, by rotating the tooth of 90 degrees relative to a central axis of the tooth.

12. A tooth according to claim 1, wherein the plurality of sides comprises four sides, each with a corresponding cutting edge.

13. A tooth according to claim 12, wherein the holder side and the outer side are substantially identical.

14. A tooth according to claim 13, wherein the tooth comprises at least one beveled side corner at an intersection of two adjacent ones of said plurality of sides.

15. A tooth according to claim 14, wherein said at least one beveled side corner comprises a corner cutting edge.

16. A tooth according to claim 15, wherein each of said cutting edges comprises two corner cutting edges.

17. A tooth according to claim 12, wherein said cutting end comprises four protruding cutting tips.

18. The saw tooth according to claim 1, wherein a transverse clearance of the tooth is greater than 0.2 inches, said transversal clearance being equal to the transverse distance between said at least one cutting edge and a corresponding edge of the mounting end.

19. A tooth according to claim 1, wherein said cutting end comprises a recessed profile.

20. A tooth according to claim 1, wherein the tooth comprises a central bore extending from the mounting end to the cutting end.

21. A tooth according to claim 1, wherein the holder side has a curved profile which substantially matches a surface of the holder.

22. A tooth according to claim 1, wherein the holder side has a curved profile which closely fits an outer surface of the circular saw or of the mower drum.

23. A tooth according to claim 1, wherein the outer side of the tooth comprises at least two different diverging segments, the outer side of the tooth being non-linear and diverging out from the mounting end to the cutting end, so as to enable the at least one cutting edge to extend beyond a corresponding mounting edge by at least 0.2 inches, thereby increasing a transversal clearance of the tooth.

24. A tooth for use with a rotatable circular saw, the tooth being mountable onto a holder of the circular saw, and comprising:
a mounting end for mounting against a component of the holder;
a cutting end, opposite to the mounting end, the cutting end being provided with a plurality of cutting edges for cutting applications;
a plurality of sides diverging from the mounting end to the cutting edges of the cutting end, the plurality of sides including at least one holder side mountable against the holder of the circular saw, and at least one outer side opposite to the holder side, the outer side of the tooth being concavely non-linear.

25. An assembly for tree felling applications, the assembly comprising:
at least one tooth according to claim 1; and
at least one holder of the circular saw or mower drum.

26. The assembly according to claim 25, wherein the holder comprises a surface for facing the holder side of the tooth, said surface being curved, and wherein the holder side of the tooth has a curved profile, which substantially matches said surface of the holder.
